(19) United States
(12) Patent Application Publication
(10) Pub. No.: US 2025/0291523 A1
(43) Pub. Date: Sep. 18, 2025

(54) INFORMATION PROCESSING SYSTEM, USER TERMINAL, SERVER, AND NON-TRANSITORY COMPUTER READABLE MEDIUM

(71) Applicant: FUJIFILM Business Innovation Corp., Tokyo (JP)

(72) Inventor: Hirofumi OGAWA, Kanagawa (JP)

(73) Assignee: FUJIFILM Business Innovation Corp., Tokyo (JP)

(21) Appl. No.: 18/775,251

(22) Filed: Jul. 17, 2024

(30) Foreign Application Priority Data
Mar. 12, 2024 (JP) 2024-038120

(51) Int. Cl. G06F 3/12

(52) U.S. Cl. CPC G06F 3/1205; G06F 3/1253; G06F 3/126; G06F 3/1288

(57) ABSTRACT

An information processing system including:
a user terminal; and
a server that transmits a print job registered from the user terminal to a printer selected as a destination,
wherein the server notifies the user terminal of, as a response to an inquiry from the user terminal, information for identifying a printer used by a user who operates the user terminal to log in to a printing service, and
wherein the user terminal displays a first setting screen corresponding to the printer identified by the information obtained from the server.

### CROSS-REFERENCE TO RELATED APPLICATIONS

This application is based on and claims priority under 35 USC 119 from Japanese Patent Application No. 2024-038120 filed Mar. 12, 2024.

### BACKGROUND

### (i) Technical Field

The present disclosure relates to an information processing system, a user terminal, a server, and a non-transitory computer readable medium.

### (ii) Related Art

Printing services that utilize the cloud are now in practical use. A user who uses this type of print service can freely output a document registered in a cloud server from any printer.

Examples of the related art include Japanese Unexamined Patent Application Publication No. 2021-124791.

### SUMMARY

The number and types of printers managed by a cloud server are larger than those in a local environment. For this reason, it is difficult for a user who does not know internet protocol (IP) addresses or device names of printers to select a specific printer from a driver selection field.

Aspects of non-limiting embodiments of the present disclosure relate to enabling a user to easily display, on a user terminal, a setting screen corresponding to a printer that the user desires to output a print job to even when the user does not know an IP address or a device name of the printer.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a user terminal and a server that transmits a print job registered from the user terminal to a printer selected as a destination, wherein the server notifies the user terminal of, as a response to an inquiry from the user terminal, information for identifying a printer used by a user who operates the user terminal to log in to a printing service, and. wherein the user terminal displays a first setting screen corresponding to the printer identified by the information obtained from the server.

### BRIEF DESCRIPTION OF THE DRAWINGS

Exemplary embodiments of the present disclosure will be described in detail based on the following figures, wherein:

FIG. 1 is a diagram illustrating a cloud printing system;

FIG. 2 is a diagram illustrating an example of hardware configuration of a server;

FIG. 3 is a diagram illustrating an example of data structure of a login list;

FIG. 4 is a diagram illustrating an example of hardware configuration of a user terminal;

FIG. 5 is a diagram illustrating an example of hardware configuration of a printer having a function of reading an image;

FIG. 6 is a diagram illustrating a user's action until a print job is registered in a first exemplary embodiment;

FIG. 7 is a diagram illustrating an example of a processing sequence according to the first exemplary embodiment related to initial registration of a print job;

FIG. 8 is a diagram illustrating updating of the login list through overwriting;

FIG. 9 is a diagram illustrating updating of the login list through addition;

FIG. 10 is a diagram illustrating a display example of a menu screen and a common driver setting screen;

FIG. 11 is a diagram illustrating an example of a setting screen for a dedicated driver corresponding to a printer with which the user has logged in last;

FIG. 12 is a diagram illustrating an example of the user's action after the registration of a print job;

FIG. 13 is a diagram illustrating an example of a processing sequence according to the first exemplary embodiment related to execution of a registered print job;

FIG. 14 is a diagram illustrating an example of the user's action until a print job is registered;

FIG. 15 is a diagram illustrating an example of a processing sequence according to a second exemplary embodiment related to initial registration of a print job;

FIG. 16 is a diagram illustrating an example of a setting screen for a dedicated driver corresponding to a printer with which the user has logged in last;

FIG. 17 is a diagram illustrating an example of hardware configuration of a user terminal according to the second exemplary embodiment;

FIG. 18 is a diagram illustrating an example of a processing sequence in a case where, after enabling a fix setting of a setting screen for a dedicated driver corresponding to a printer, the user logs in to a cloud printing service with another printer and then registers a print job;

FIG. 19 is a diagram illustrating updating of the login list through overwriting;

FIG. 20 is a diagram illustrating updating of the login list through addition;

FIG. 21 is a diagram illustrating a difference in the setting screen depending on presence or absence of the fix setting;

FIG. 22 is a diagram illustrating another example of the processing sequence in the case where, after enabling the fix setting of the setting screen for the dedicated driver corresponding to the printer, the user logs in to the cloud printing service with another printer and then registers a print job;

FIG. 23 is a diagram illustrating another display example of the common driver setting screen;

FIG. 24 is a diagram illustrating an example of a processing sequence according to a third exemplary embodiment related to initial registration of a print job;

FIG. 25 is a diagram illustrating an example of an inquiry screen displayed on an operation panel;

FIG. 26 is a diagram for explaining an example of data structure of a login list used in the third exemplary embodiment;

FIG. 27 is a diagram illustrating a display example of a menu screen in the third exemplary embodiment;

FIG. 28 is a diagram illustrating a display example of a common driver setting screen in the third exemplary embodiment; and

FIG. 29 is a diagram illustrating another example of the processing sequence related to the initial registration of a print job.

### DETAILED DESCRIPTION

Exemplary embodiments of the present disclosure will be described with reference to the drawings.

### First Exemplary Embodiment

### System Configuration

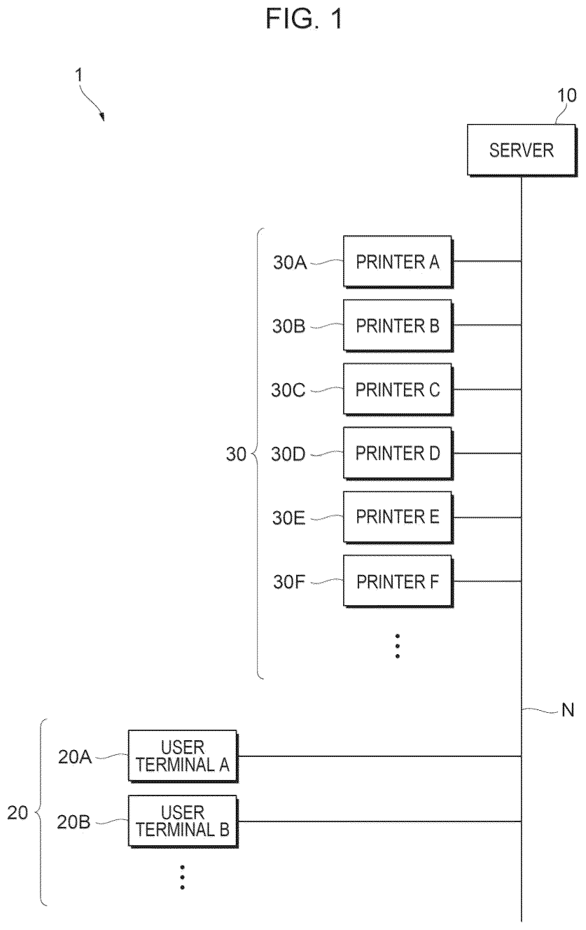

FIG. 1 is a diagram illustrating a cloud printing system 1. The cloud printing system 1 includes a server 10 that provides a cloud printing service, user terminals 20 operated by users, and printers 30 connected to a cloud network N.

The cloud printing system 1 herein is an example of an information processing system.

A user of the cloud printing service can select, using any printer 30, a print job uploaded in advance and execute the print job. The cloud printing service is an example of a printing service and can be used only by users registered as customers.

The server 10 illustrated in FIG. 1 is a cloud server. The server 10 includes one or a plurality of servers. The server 10 manages storage of print jobs uploaded from the user terminals 20 and output of print jobs to the printers 30 with which the users perform login operations.

The user terminals 20 illustrated in FIG. 1 are, for example, desktop computers, laptop computers, tablet computers, or smartphones. Alternatively, the user terminal 20 may be so-called wearable terminals. A wearable terminal may be of a wristwatch type, a ring type, or a glasses type. Examples of the glasses-type wearable terminal include smart glasses and augmented reality (AR) glasses.

In FIG. 1, a user terminal 20 used by a user A will be referred to as a “user terminal A” or a “user terminal 20A”. A “user terminal 20” will be used hereinafter as a generic term for the user terminal 20A, 20B, or the like.

The printers 30 are apparatuses having at least a function of printing documents on sheets of paper. In this sense, the printers 30 can also be called “image forming apparatuses”. The printers 30 may be dedicated to printing or have other functions. The other functions include, for example, duplication printing (so-called copy printing), reading of documents (scanning), and facsimile.

The printers 30 illustrated in FIG. 1 may be installed at any places and are present at a plurality of places. In FIG. 1, each of the printers 30 is distinguished from the other printers 30 by using an expression such as a “printer A” or a “printer 30A”. A “printer 30” will be used hereinafter as a generic term for the printer 30A, 30B, 30C, 30D, 30E, 30F, or the like.

### Configuration of Server

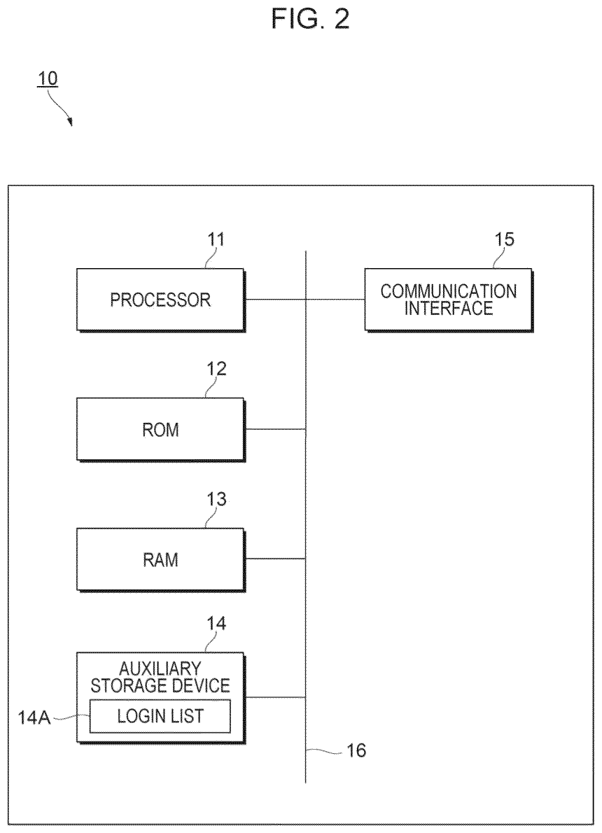

FIG. 2 is a diagram illustrating an example of hardware configuration of the server 10.

The server 10 illustrated in FIG. 2 includes a processor 11, a read-only memory (ROM) 12 storing a basic input/output system (BIOS) and the like, a random-access memory (RAM) 13 used as a work area of the processor 11, an auxiliary storage device 14, and a communication interface 15. These devices are connected to one another via a bus or another signal line 16.

The processor 11 is a device that achieves various functions through execution of a program. The processor 11, the ROM 12, and the RAM 13 function as a computer.

The communication interface 15 is an interface that achieves communication with the user terminals 20 and the printers 30. The communication interface 15 supports various communication standards. The communication standards here include, for example, Ethernet (registered trademark), Wi-Fi (registered trademark), and mobile communication systems.

The auxiliary storage device 14 includes, for example, a hard disk device or a semiconductor storage. The auxiliary storage device 14 stores therein programs and various types of data. The “programs” are used as a generic term for an operating system (OS) and application programs.

In the present exemplary embodiment, a login list 14A is stored in the auxiliary storage device 14. The login list 14A is an example of information for identifying printers 30 used by users to log in to the cloud printing service.

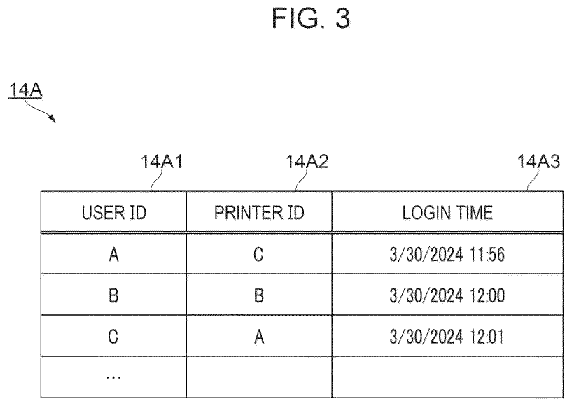

FIG. 3 is a diagram illustrating an example of data structure of the login list 14A.

The login list 14A illustrated in FIG. 3 includes user identifiers (IDs) 14A1, which are information for identifying users, printer IDs 14A2, which are information for identifying printers 30 used to log in to the cloud printing service, and login times 14A3.

As a user ID, for example, an account name of a user, information associated with registration information regarding a user, an Internet protocol (IP) address of a user terminal 20, a device name of a user terminal 20, or a media access control (MAC) address of a user terminal 20 is used.

As a printer ID, for example, a device name of a printer 30, an IP address of a printer 30, or an MAC address of a printer 30 is used.

In FIG. 3, for example, it can be seen that the user A has logged in to the cloud printing service by operating the printer C at “3/30/2024 11:56”.

### Configuration of User Terminal

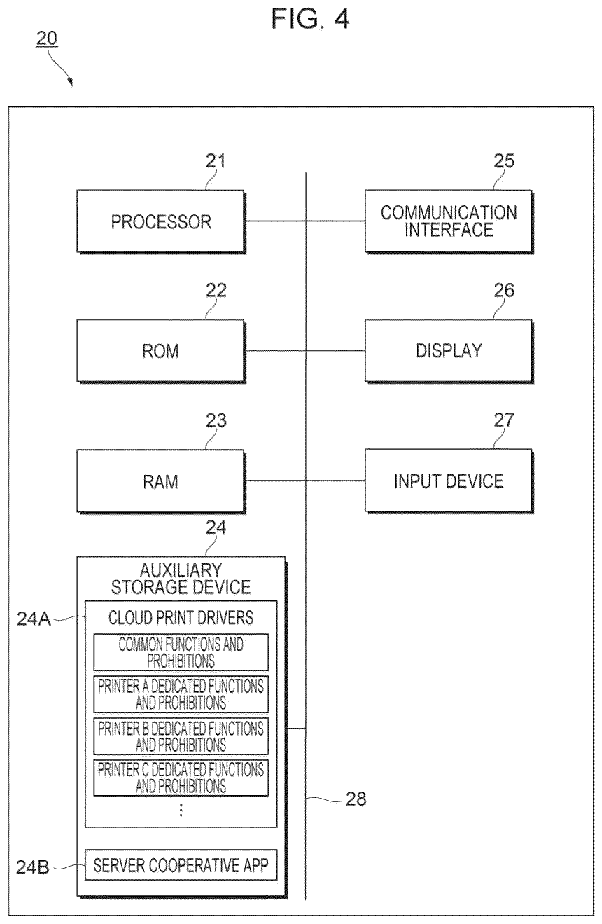

FIG. 4 is a diagram illustrating an example of hardware configuration of the user terminal 20.

The user terminal 20 illustrated in FIG. 4 includes a processor 21, a ROM 22 storing a BIOS and the like, a RAM 23 used as a work area of the processor 21, an auxiliary storage device 24, a communication interface 25, a display 26, and an input device 27. The devices are connected to one another through a bus or another signal line 28.

The auxiliary storage device 24 is, for example, a hard disk device or a semiconductor storage. The auxiliary storage device 24 stores programs and various types of data.

In the present exemplary embodiment, the auxiliary storage device 24 stores a cloud print driver 24A and a server cooperative app 24B.

The cloud print drivers 24A are, for example, print drivers provided by a manager of the cloud printing service.

The cloud print drivers 24A include, for example, a driver corresponding to functions and prohibitions common to the printers 30A, 30B, 30C, 30D, 30E, 30F (see FIG. 1), and the like connected to the cloud network N and drivers corresponding to functions and prohibitions unique to the individual printers 30.

In FIG. 4, the former driver is indicated as “common functions and prohibitions”, and the latter drivers are indicated as “printer A functions and prohibitions”, “printer B functions and prohibitions”, “printer C functions and prohibitions”, and the like.

The cloud print drivers 24A, however, may include only the driver corresponding to the functions and the prohibitions common to all the printers 30, instead.

The server cooperative app 24B is an application program that achieves cooperation with the server 10 (see FIG. 1) when the cloud printing service is used. The server cooperative application 24B, for example, downloads the login list 14A (see FIG. 2) and controls display of a property setting screen to be presented to the user.

The display 26 is, for example, a liquid crystal display or an organic electroluminescent (EL) display.

The input device 27 is, for example, a mouse and a keyboard. When the user terminal 20 is a laptop computer, a tablet computer, or a smartphone, a capacitive touch sensor that has transparency so that visual recognition of an image displayed on the display 26 is not hindered is used as the input device 27. This type of device that is a combination of a touch sensor and the display 26 is called a touch panel.

### Configuration of Printer

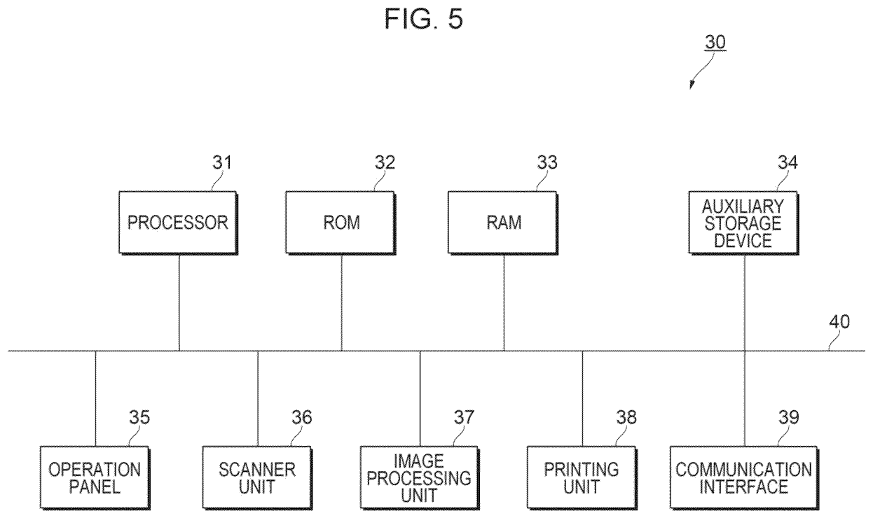

FIG. 5 is a diagram illustrating an example of hardware configuration of the printer 30 having the function of reading an image.

The printer 30 includes a processor 31, a ROM 32 storing a BIOS, firmware, and the like, a RAM 33 used as a work area for the processor 31, an auxiliary storage device 34, an operation panel 35, a scanner unit 36, an image processing unit 37, a printing unit 38, and a communication interface 39.

The processor 31 is a device that achieves various functions through execution of the firmware. The processor 31, ROM 32, and RAM 33 function as a computer.

The auxiliary storage device 34 is, for example, a hard disk device or a semiconductor storage. The auxiliary storage device 34 stores, for example, print jobs and images of documents.

The operation panel 35 is, for example, a touch panel.

The scanner unit 36 includes, for example, a light source that radiates illumination light onto a document, an image sensor that captures an image of the document, and a mechanism that conveys the document.

The image processing unit 37 is a processing unit that performs color correction, gradation correction, and other types of image processing on, for example, print jobs or images of documents.

The printing unit 38 is a mechanism that forms an image on a sheet of paper by, for example, an electrophotographic method or an inkjet method.

The communication interface 39 is an interface that achieves communication with the server 10 (see FIG. 1).

### Description of Processing Operations

Processing operations performed by the cloud printing system 1 (see FIG. 1) assumed in the first exemplary embodiment will be described hereinafter.

### Until Initial Registration of Print Job

### User's Action

A user who uses the cloud printing service can call a print job uploaded to the server 10 (see FIG. 1) to any printer 30 connected to the cloud network N and execute the print job. Models and functions of the printers 30 (see FIG. 1) connected to the cloud network N are not the same. For this reason, there is a case where a printer 30 that does not support functions and prohibitions specified in a print job cannot print an image desired by the user on a sheet of paper. Even when the user has specified color printing, for example, the user can obtain only a printed matter in monochrome if a printer 30 with which the user has called a print job supports only monochrome printing.

In order to solve this problem, a printer 30 capable of performing printing desired by the user may be identified in advance, and a print job generated using a setting screen for a driver corresponding to the identified printer 30 may be uploaded to the server 10.

Even when a driver corresponding to a specific printer 30 is to be selected, however, it is difficult to select the specific printer 30 in a driver selection field unless an IP address, a device name, or the like of the specific printer 30 is known.

If a common driver applicable to all the printers 30 is used, there is no discrepancy between settings and a printed matter, but settable functions and prohibitions are limited. As a result, a printed matter desired by the user is not obtained.

In the present exemplary embodiment, therefore, the login list 14A (see FIG. 2) is used to support generation of a print job for a specific printer 30.

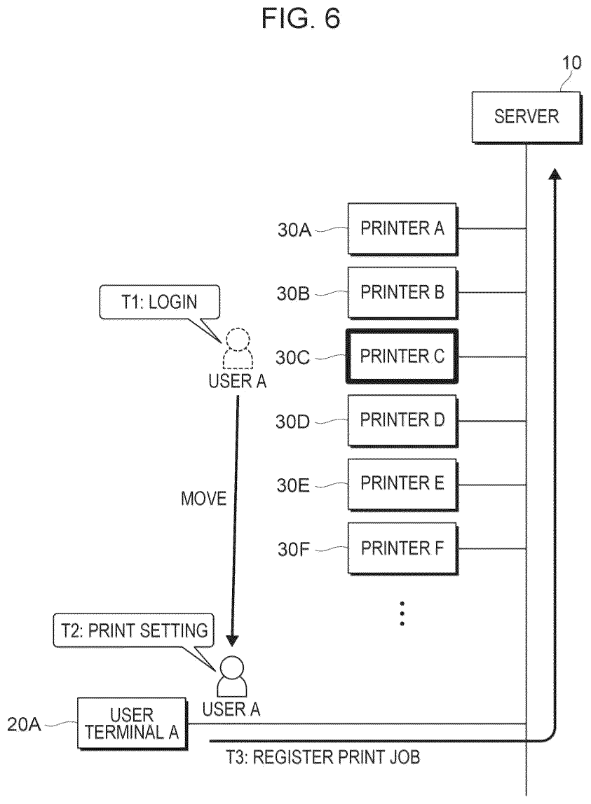

FIG. 6 is a diagram illustrating action of the user A until a print job is registered in the first exemplary embodiment. In FIG. 6, elements corresponding to those in FIG. 1 are given the same reference numerals.

First, the user A logs in to the cloud printing service at a time T1. More specifically, the user A logs in to the server 10 using the printer 30C. This login information is recorded in the login list 14A of the server 10. The printer 30C used for the login will be referred to as a login source.

Next, at a time T2, the user A operates the user terminal 20A to call a setting screen for the printer 30C, and performs print setting.

Thereafter, at a time T3, the user terminal 20A registers a print job to the server 10.

### Processing Sequence

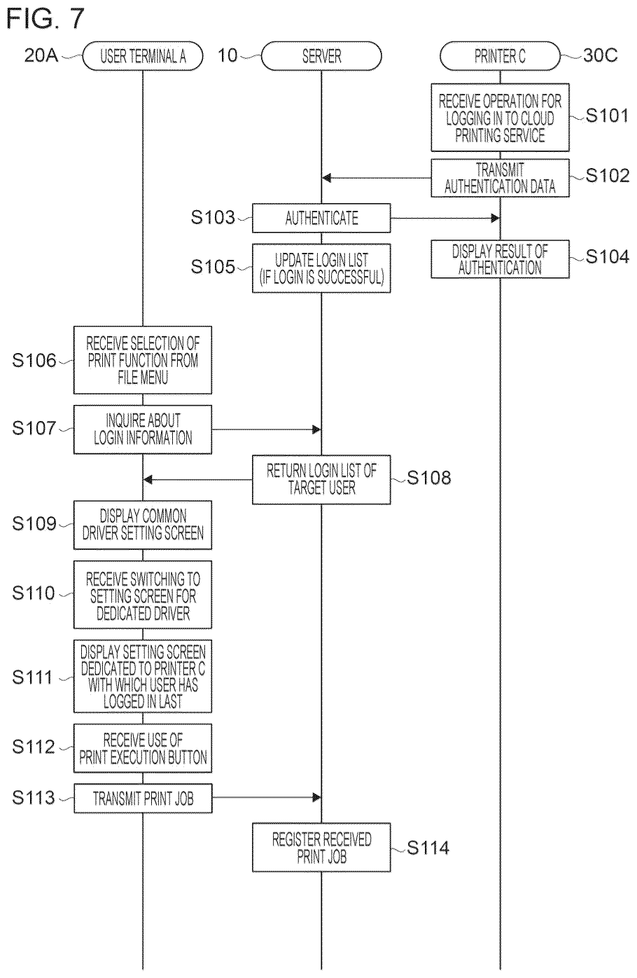

FIG. 7 is a diagram illustrating an example of a processing sequence according to the first exemplary embodiment related to initial registration of a print job. A symbol S illustrated in the drawings represents a step.

The printer 30C starts the processing sequence illustrated in FIG. 7 as described with reference to FIG. 6.

When the printer 30C receives an operation for logging in to the cloud printing service (step 101), the printer 30C transmits authentication data to the server 10 (step 102). The authentication data is input, for example, through the operation panel 35 (see FIG. 5). When a card reader is provided for the printer 30C, the authentication data may be read from an integrated circuit (IC) card such as an employee ID card.

Upon receiving the authentication data, the server 10 authenticates the user (step 103). That is, it is determined whether the login user has authority to use the cloud printing service.

The server 10 notifies the printer 30C of a result of the authentication. The printer 30C displays the received result of the authentication (step 104).

If the authentication is successful, the server 10 updates the login list 14A (step 105). More specifically, the login of the user A to the cloud printing service from the printer 30C is recorded. Not only a login for which authentication has succeeded but also a login for which authentication has failed may be recorded in the login list 14A. In that case, results of the authentication are also recorded in the login list 14A.

The update of the login list 14A includes overwriting and addition.

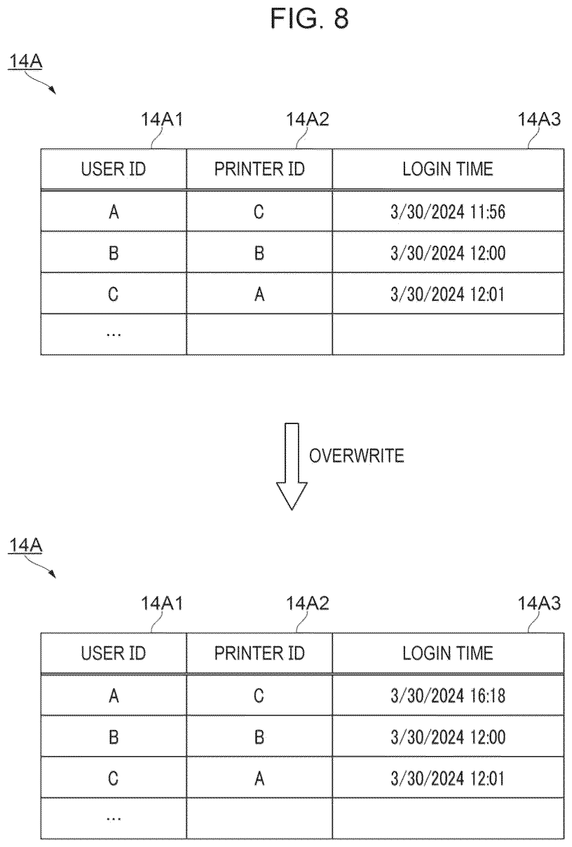

FIG. 8 is a diagram illustrating updating of the login list 14A through overwriting. In FIG. 8, elements corresponding to those in FIG. 3 are given the same reference numerals.

In the case of overwriting, only a last login time for each user is recorded in the login list 14A. In FIG. 8, therefore, “3/30/2024 16:18” is recorded as the last login time of the user A. A printer 30 used for a login operation is the same printer C as that used for a previous login operation.

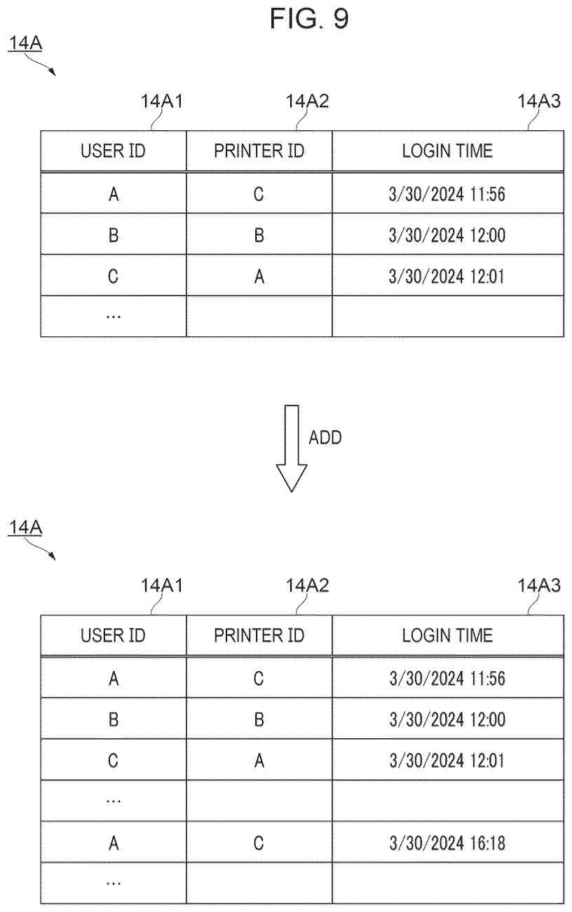

FIG. 9 is a diagram illustrating updating of the login list 14A through addition. In FIG. 9, elements corresponding to those in FIG. 3 are given the same reference numerals.

In the case of addition, all login times related to each user are recorded in the login list 14A. In FIG. 9, therefore, not only the previous login time of the user A but also the last login time are recorded.

FIG. 7 will be referred to again.

Thereafter, the user terminal 20A receives selection of a print function from a file menu of a document (step 106). In other words, the user terminal 20A receives a printing operation.

The document is, for example, text data, graphic data, image data, photograph data, or a combination of these, and includes data similar to this.

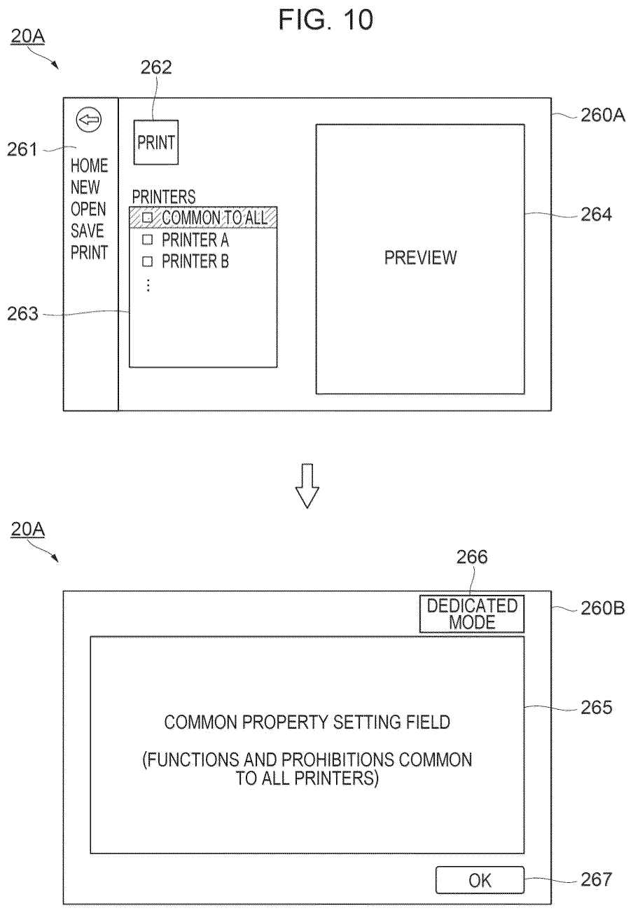

When the print function is selected in a function selection field 261 (see FIG. 10), the user terminal 20A accesses the server 10 through the server cooperative app 24B (see FIG. 4) and inquires about login information (step 107).

The server 10 returns the login list 14A (see FIG. 2) of the target user as a response to the inquiry (step 108). In other words, the user terminal 20A obtains the login list 14A from the server 10.

Next, the user terminal 20A displays a common driver setting screen 260B (see FIG. 10) (step 109).

The common driver setting screen 260B is a screen for setting the functions and prohibitions common to all the printers 30 selectable in the cloud printing service.

FIG. 10 is a diagram illustrating a display example of a menu screen 260A and the common driver setting screen 260B.

The menu screen 260A illustrated in FIG. 10 includes the function selection field 261, a print execution button 262, a driver selection field 263, and a preview screen 264.

The function selection field 261 is provided with, for example, a “back” button, a “home” button, a “new” button, an “open” button, a “save” button, and a “print” button.

The menu screen 260A illustrated in FIG. 10 is a display screen after use of the “print” button in the function selection field 261.

In the driver selection field 263, the drivers (e.g., “printer A”, “printer B”, etc.) corresponding to the individual printers 30 and the driver (e.g., “common to all”) corresponding to the functions and the prohibitions common to all the printers 30 are displayed in a selectable manner. A square at a head of each row is an icon corresponding to each driver.

In the driver selection field 263 illustrated in FIG. 10, a state in which the driver with the device name “common to all” has been selected is expressed by hatching.

The common driver setting screen 260B is displayed by selecting the driver with the device name “common to all” in the driver selection field 263. The common driver setting screen 260B is an example of a second setting screen. The common driver setting screen 260B is also an example of an initial screen.

The common driver setting screen 260B illustrated in FIG. 10 is provided with a common property setting field 265, a “dedicated mode” button 266, and an “OK” button 267.

In the common property setting field 265, it is possible to make settings for the functions and the prohibitions common to all the printers.

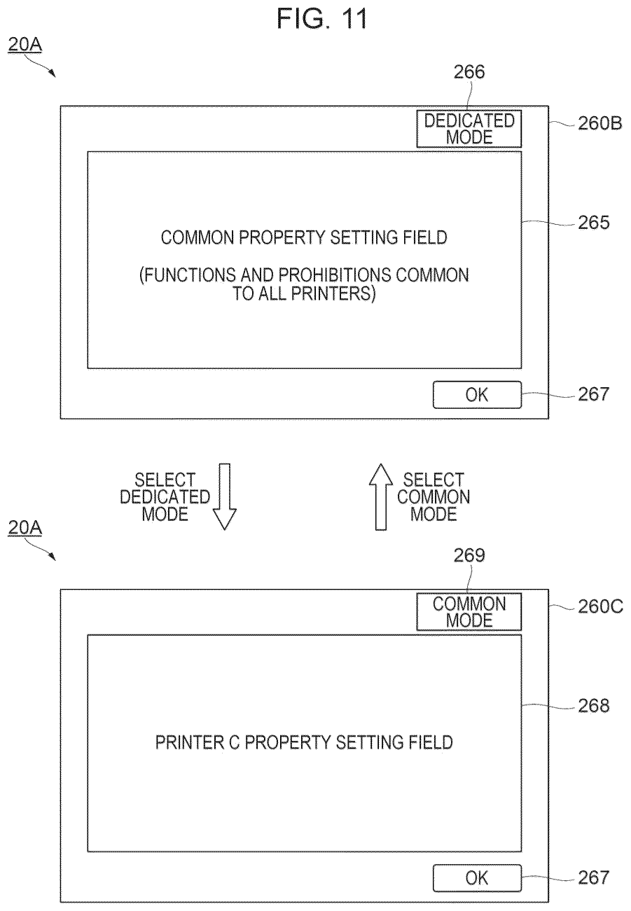

The “dedicated mode” button 266 is a button for switching to a setting screen 260C (see FIG. 11) corresponding to a printer 30 with which the user has logged in last. By using the “dedicated mode” button 266, for example, the setting screen 260B switches to the setting screen 260C for the printer 30C.

When the “OK” button 267 is used, set properties are confirmed, and the menu screen 260A is displayed again.

FIG. 7 will be referred to again.

In FIG. 7, the user terminal 20A receives switching to a dedicated driver setting screen while displaying the common driver setting screen 260B (see FIG. 10) (step 110). More specifically, the user terminal 20A receives use of the “dedicated mode” button 266 (see FIG. 10).

In this case, the user terminal 20A displays the setting screen 260C (see FIG. 11) dedicated to the printer 30C, with which the user has logged in last (step 111). The printer 30C with which the user has logged in last can be identified from the login list 14A (see FIG. 3).

FIG. 11 is a diagram illustrating an example of a setting screen for a dedicated driver corresponding to a printer with which the user has logged in last. In FIG. 11, elements corresponding to those in FIG. 10 are given the same reference numerals.

An upper part of FIG. 11 illustrates the common driver setting screen 260B, and a lower part of FIG. 11 illustrates the setting screen 260C for the dedicated driver corresponding to the printer 30C with which the user has logged in last. The setting screen 260C for the dedicated driver is an example of a first setting screen.

The setting screen 260C for the dedicated driver illustrated in FIG. 11 is provided with a setting field 268 for properties of the printer C, a “common mode” button 269, and an “OK” button 267.

Settings related to the functions and the prohibitions unique to the printer C can be made in the setting field 268 for the printer C.

The “common mode” button 269 is a button for switching to the common driver setting screen 260B.

When the “OK” button 267 is used, set properties are confirmed, and the menu screen 260A (see FIG. 10) is displayed again.

FIG. 7 will be referred to again.

In FIG. 7, the user terminal 20A receives use of the print execution button 262 (see FIG. 10) on the menu screen 260A (see FIG. 10) (step 112).

Thereafter, the user terminal 20A transmits the print job to the server 10 (step 113).

The server 10 registers the received print job (step 114).

The processing operations up to the registration of a print job thus ends.

If the user desires to register another print job, the user only needs to repeat the processing from step 106 to step 114.

The user can set a print job using the common driver setting screen 260B (see FIG. 11), or can set the properties using a setting screen for a specific dedicated driver specified in the driver selection field 263 (see FIG. 10).

### Execution of Registered Print Job

### User's Action

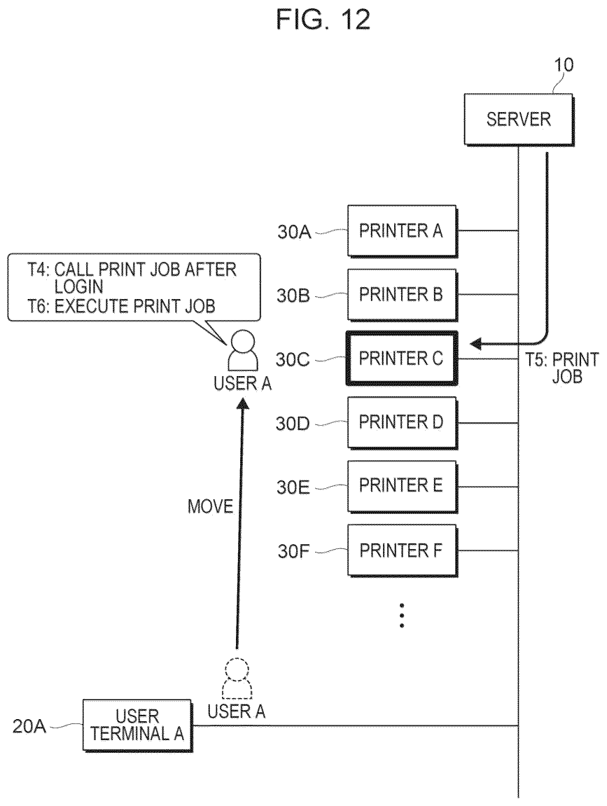

FIG. 12 is a diagram illustrating an example of the user's action after the registration of a print job. In FIG. 12, elements corresponding to those in FIG. 6 are given the same reference numerals.

First, the user A moves to the printer 30C at a time T4. The user A then logs in to the server 10 using the printer 30C, and calls print jobs registered thereby. The print jobs here are unexecuted print jobs. Any drivers may be used to set the print jobs.

Not only print jobs set with the dedicated driver corresponding to the printer 30C used for the login but also print jobs set with dedicated drivers corresponding to the other printers 30 (e.g., the printer 30A) and print jobs set with the common driver, therefore, are displayed.

At a next time T5, the server 10 calls a specific print job specified by the user A to the printer 30C.

Thereafter, at a time T6, the printer 30C performs printing.

### Processing Sequence

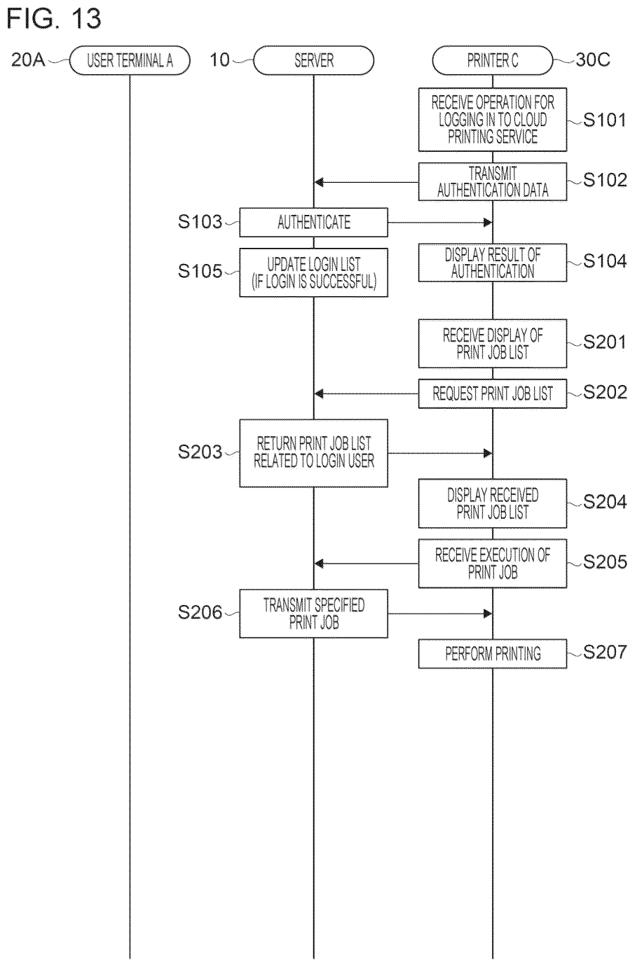

FIG. 13 is a diagram illustrating an example of a processing sequence according to the first exemplary embodiment related to execution of a registered print job. In FIG. 13, elements corresponding to those in FIG. 7 are given the same reference numerals.

The processing sequence illustrated in FIG. 13 also starts when the printer 30C receives an operation for logging in to the cloud printing service (step 101). The processing up to step 105 is the same as that in the processing sequence illustrated in FIG. 7.

If the authentication is successful, the user A can request a print job list through the operation panel 35 (see FIG. 5) of the printer 30C.

In FIG. 13, the printer 30C receives display of a print job list after step 104 (step 201).

In this case, the printer 30C requests a print job list from the server 10 (step 202).

In response to the request from the printer 30C, the server 10 returns a print job list related to the user A who has logged in (step 203).

The printer 30C displays the received print job list (step 204), and receives execution of the print job from the user A (step 205). The number of print jobs to be received as an execution target is not limited to one, and may be plural, instead.

In response to the request from the printer 30C, the server 10 transmits the specified print job (step 206).

Thereafter, the printer 30C performs printing in accordance with the received print job (step 207).

### SUMMARY

When the cloud printing system 1 (see FIG. 1) described in the present exemplary embodiment is employed, the user can call the setting screen 260C (see FIG. 11) for a dedicated driver corresponding to a printer 30 that the user desires to use for output only by using the “dedicated mode” button 266 (see FIG. 11) prepared on the common driver setting screen 260B (see FIG. 11).

In other words, even when the user does not know an IP addresses or a device name of a printer 30 to which the user desires to output a print job, the user can set properties on the setting screen 260C for a dedicated driver corresponding to the specific printer 30 by operating the specific printer 30 to log in to the cloud printing service immediately before setting the properties.

As a result, as compared with a case where properties are set on the common driver setting screen 260B, there are more settable functions and prohibitions, and printing in a mode desired by the user can be performed.

If the displayed setting screen 260C for the dedicated driver does not include an item that the user desires to set, the user may move to another printer 30 and repeat the operation for logging in to the cloud printing service. Although the user needs to spend more time and effort due to the movement and the like, the user can find a printer 30 including an item that the user desires to set even if he/she does not know an IP address or a device name of the printer 30.

In addition, in the case of the cloud printing system 1 described in the present exemplary embodiment, the user can reliably display a setting screen 260C for a dedicated driver corresponding to a printer 30 that the user desires to use only by logging in to the cloud printing service with the printer 30. For this reason, it is possible to eliminate a printing failure caused by a mismatch between a setting screen for a dedicated driver used to set a print job and functions and prohibitions supported by a printer 30 used for the print job.

### Second Exemplary Embodiment

In the present exemplary embodiment, a modification of the first exemplary embodiment will be described.

A cloud printing system 1 (see FIG. 1) assumed in the second exemplary embodiment, therefore, is the same as the cloud printing system 1 described in the first exemplary embodiment.

Hardware configuration and the like of a server 10 (see FIG. 1), user terminals 20 (see FIG. 1), and printers 30 (see FIG. 1) assumed in the second exemplary embodiment, too, are the same as those in the first exemplary embodiment.

Differences lie in processing performed by the cloud print drivers 24A (see FIG. 4) and the server cooperative application 24B (see FIG. 4).

### Description of Processing Operations

Processing operations performed by the cloud printing system 1 (see FIG. 1) assumed in the second exemplary embodiment will be described hereinafter.

### Until Initial Registration of Print Job

### User's Action

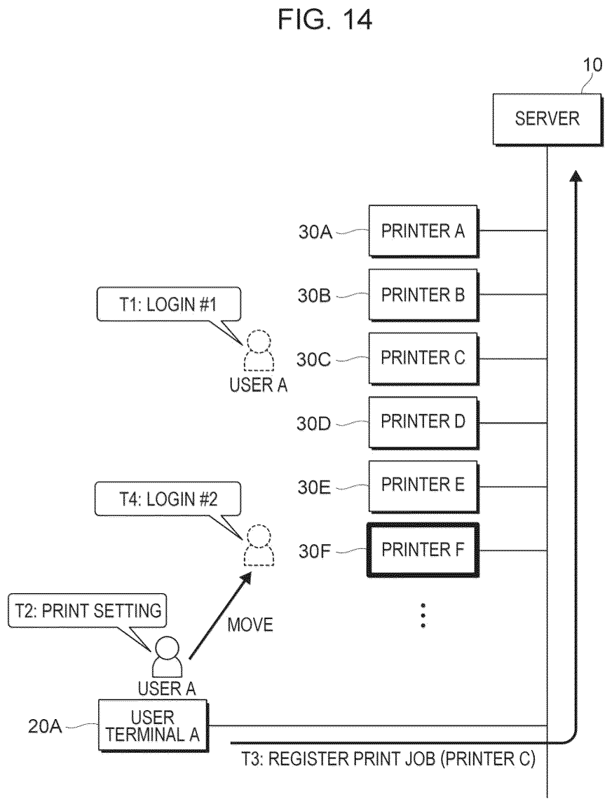

FIG. 14 is a diagram illustrating an example of the user's action until a print job is registered. In FIG. 14, elements corresponding to those in FIG. 6 are given the same reference numerals.

In FIG. 14, too, the action of the user A from the time T1 to the time T3 is the same as in FIG. 6. That is, the user A sets properties on the setting screen for the dedicated driver corresponding to the printer 30C used to log in to the cloud printing service.

The user A has logged in to the cloud printing service via the printer 30F at a time T4. This login is performed, for example, when the printer 30F is closest to a current location of the user A.

In this case, too, it is possible to easily call a setting screen 260C (see FIG. 11) for a dedicated driver corresponding to the printer 30F by using the “dedicated mode” button 266 (see FIG. 11).

There is a case where the user desires to cause the printer 30C, with which the user has logged in before, to execute a print job next time.

In this case, when the cloud printing system 1 described in the first exemplary embodiment is employed, it is necessary to move from the printer 30F to the printer 30C and log in to the cloud printing service.

In the present exemplary embodiment, a mechanism for easily calling, at any time, the setting screen for the dedicated driver corresponding to the printer 30C, which is usually used by the user, will be described.

### Processing Sequence

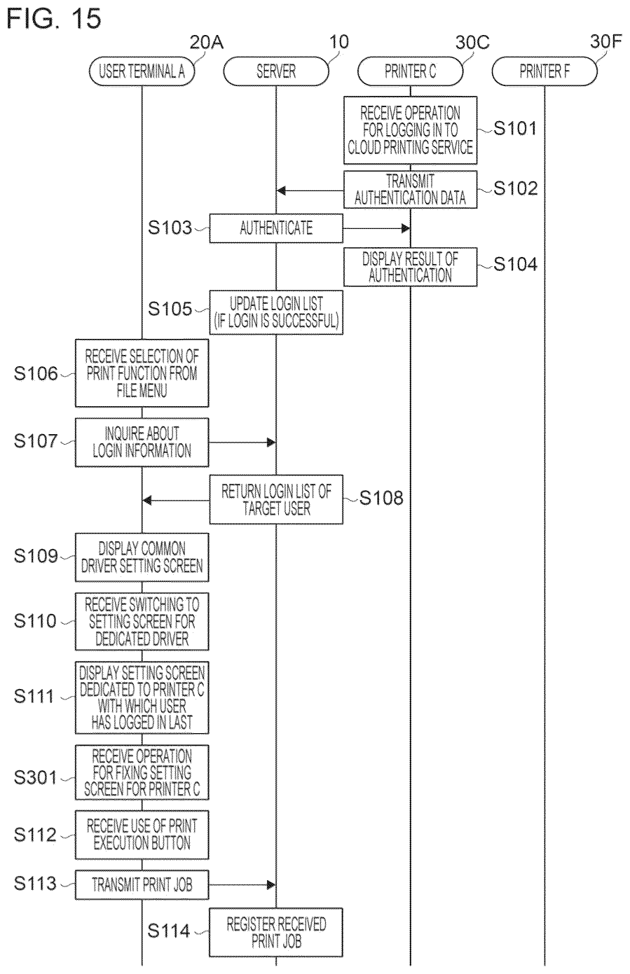

FIG. 15 is a diagram illustrating an example of a processing sequence according to the second exemplary embodiment related to initial registration of a print job. In FIG. 15, elements corresponding to those in FIG. 7 are given the same reference numerals.

In the case of the processing sequence illustrated in FIG. 15, a processing operation (step 301) where the user terminal 20A receives an operation for fixing the setting screen 260C (see FIG. 11) for the printer C (i.e., the printer 30C) is added between step 111 and step 112.

Other processing operations are the same as those in the first exemplary embodiment.

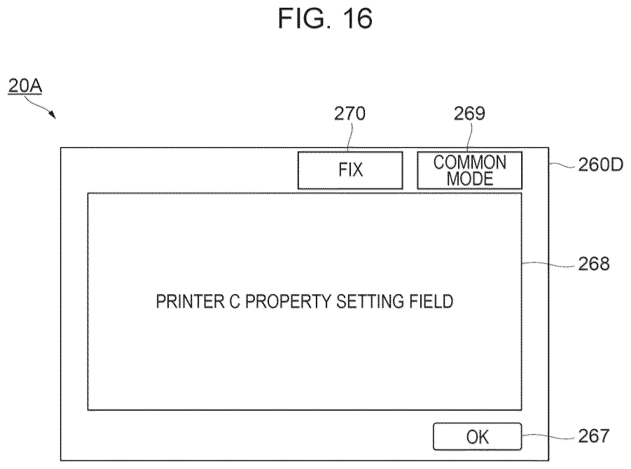

For the fixing operation here, a “fix” button 270 (see FIG. 16) is used.

FIG. 16 is a diagram illustrating an example of a setting screen for a dedicated driver corresponding to a printer with which the user has logged in last. In FIG. 16, elements corresponding to those in FIG. 11 are given the same reference numerals.

In FIG. 16, the “fix” button 270 is added.

The “fix” button 270 is a toggle switch, and a fix setting switches to a disabled state when the button is used in a state in which the fix setting is enabled, and the fix setting switches to an enabled state when the button is used in a state in which the fix setting is disabled.

In a case where the fix setting is enabled, when the “dedicated mode” button 266 (see FIG. 11) is used on the common driver setting screen 260B (see FIG. 11), a setting screen for a dedicated driver corresponding to a printer for which the fix setting is enabled is displayed in preference to a dedicated driver corresponding to a printer for which the last login is confirmed.

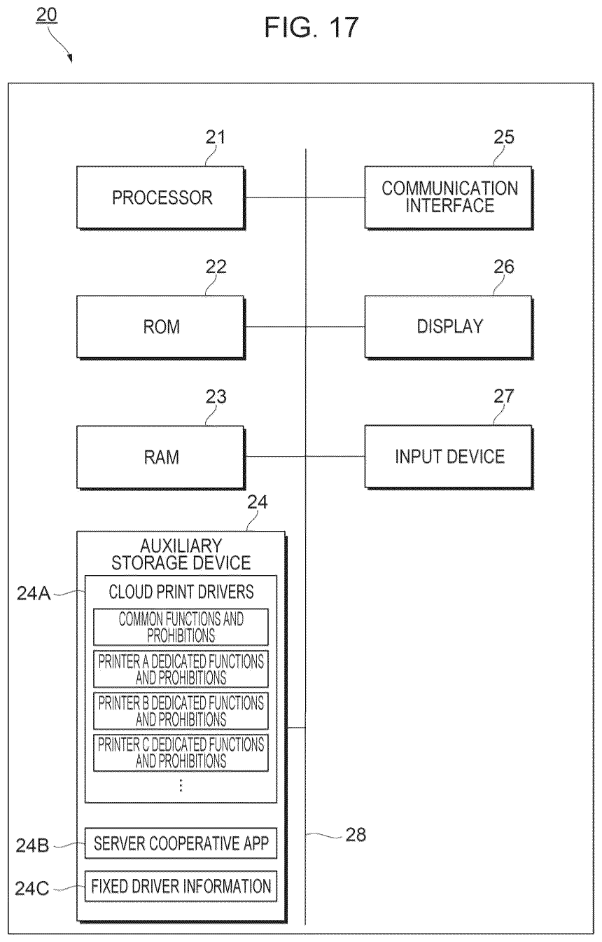

FIG. 17 is a diagram illustrating an example of hardware configuration of the user terminal 20 according to the second exemplary embodiment. In FIG. 17, elements corresponding to those in FIG. 4 are given the same reference numerals.

In FIG. 17, fixed driver information 24C is added to the auxiliary storage device 24. In the fixed driver information 24C, information for identifying a dedicated driver for which the fix setting is enabled is recorded. For example, a device name or an IP address is recorded in the fixed driver information 24C.

### Registration of Print Job After Fix Setting

### First Processing Sequence

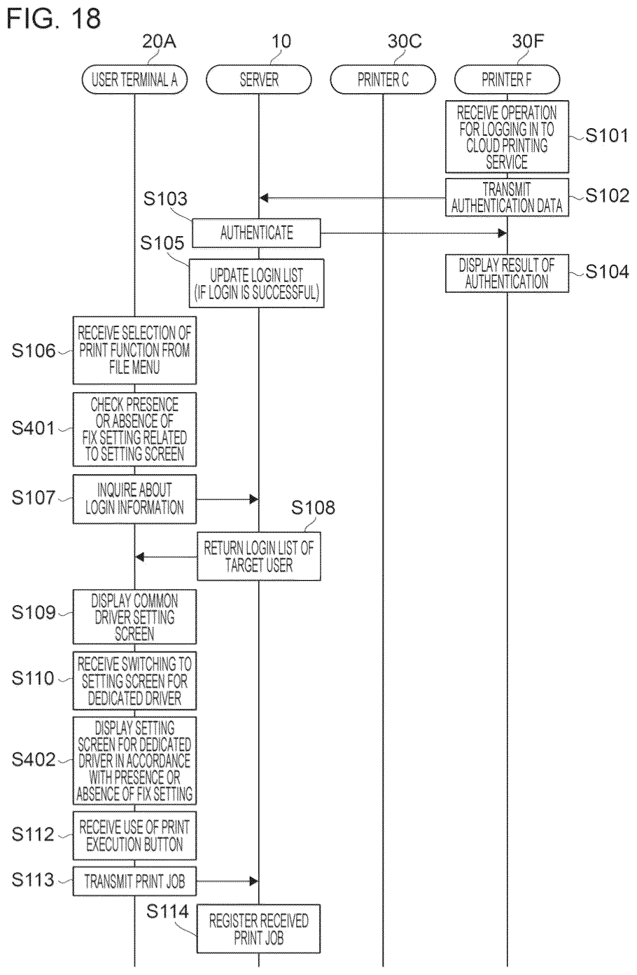

FIG. 18 is a diagram illustrating an example of a processing sequence in a case where, after enabling the fix setting of the setting screen 260D (see FIG. 16) for the dedicated driver corresponding to the printer 30C, the user logs in to the cloud printing service with another printer 30F and then registers a print job.

In FIG. 18, elements corresponding to those in FIG. 7 are given the same reference numerals.

In FIG. 18, the printer 30F receives an operation for logging in to the cloud printing service (step 101) and transmits authentication data to the server 10 (step 102).

In FIG. 7, on the other hand, the printer 30C receives an operation for logging in to the cloud printing service.

The server 10 then authenticates the received authentication data (step 103) and returns a result of the authentication to the printer 30F. The printer 30F displays the received result of the authentication (step 104). If the authentication is successful, the server 10 updates the login list 14A (step 105).

The above processing is the same as that in FIG. 15 except that data is communicated between the printer 30F and the server 10.

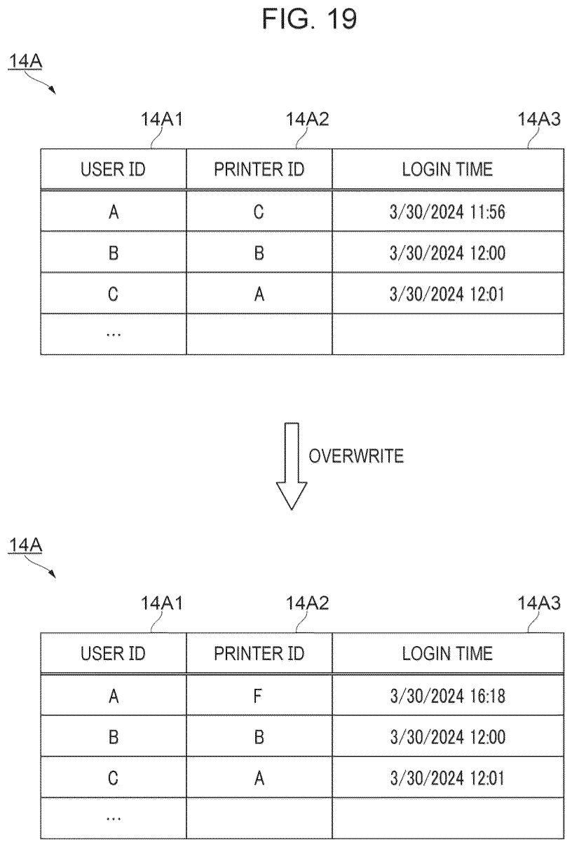

FIG. 19 is a diagram illustrating updating of the login list 14A through overwriting. In FIG. 19, elements corresponding to those in FIG. 8 are given the same reference numerals.

In FIG. 19, the printer 30F used for the login operation is recorded in association with the user A.

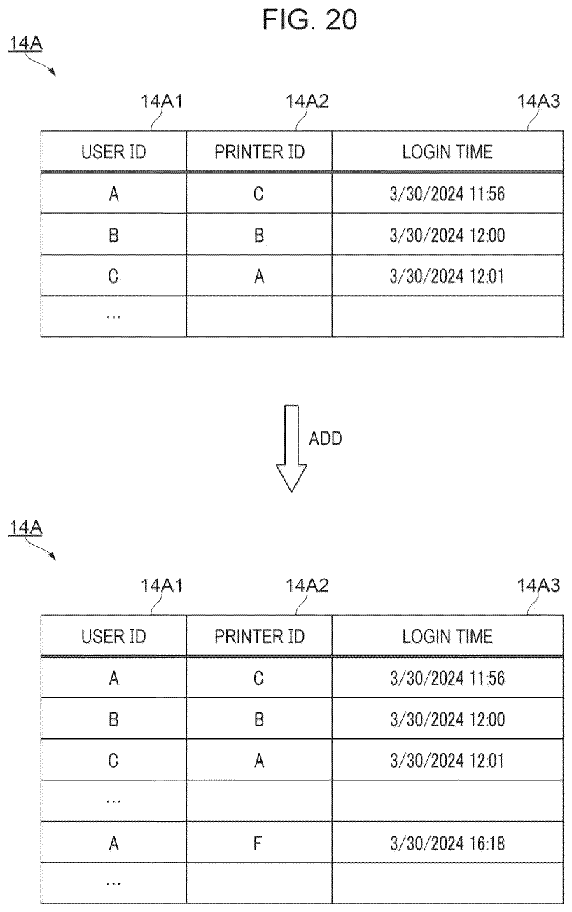

FIG. 20 is a diagram illustrating updating of the login list 14A through addition. In FIG. 20, elements corresponding to those in FIG. 9 are given the same reference numerals.

In FIG. 20, the printer 30F used for the login operation is recorded in association with the user A.

FIG. 18 will be referred to again.

Thereafter, the user A operates the user terminal 20A to receive selection of the print function from a file menu of a document (step 106).

In FIG. 18, the user terminal 20A that has detected the selection of the print function checks presence or absence of the fix setting related to the setting screen (step 401). The fix setting being “present” means a state in which the fix setting is enabled. The fix setting being “absent”, on the other hand, means a state in which the fix setting is disabled.

In FIG. 18, after presence or absence of the fix setting is checked in step 401, the login list 14A (see FIG. 3) is read from the server 10 (step 107 and step 108).

The user terminal 20A then displays the common driver setting screen 260B (see FIG. 11) (step 109) and receives switching to a setting screen for a dedicated driver (step 110).

In FIG. 18, the user terminal 20A displays the setting screen for the dedicated driver in accordance with presence or absence of the fix setting (step 402).

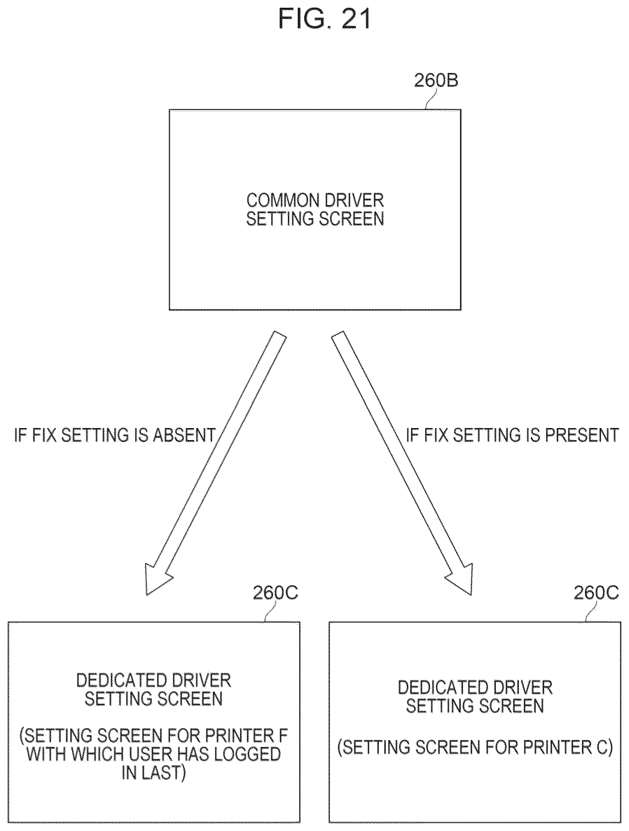

FIG. 21 is a diagram illustrating a difference in the setting screen depending on presence or absence of the fix setting.

When the fix setting is absent, the setting screen 260C for the dedicated driver corresponding to the printer 30F (see FIG. 14) with which the user has logged in last is displayed. This display is the same as that in the first exemplary embodiment.

When the fix setting is present, on the other hand, the setting screen 260D (see FIG. 16) for the dedicated driver corresponding to the printer 30C (see FIG. 14) for which the fix setting has been set to the enabled state with the “fix” button 270 (see FIG. 16) is displayed. In this case, a setting screen 260D for a dedicated driver for which the fix setting has been set to the enabled state is displayed regardless of the printer 30F with which the user A has performed the last login operation.

The user A, therefore, need not move to the printer 30C and log in to the cloud printing service in order to enable reading of the setting screen 260D for the dedicated driver corresponding to the printer 30C from the “dedicated mode” button 266 (see FIG. 11).

FIG. 18 will be referred to again.

After the settings are made on the displayed setting screen 260C, the user terminal 20A receives use of the print execution button 262 on the menu screen 260A (see FIG. 10) (step 112).

Thereafter, the user terminal 20A transmits the print job to the server 10 (step 113).

The server 10, on the other hand, registers the received print job (step 114).

### Second Processing Sequence

The display of the setting screen 260D described above can also be achieved by another processing sequence.

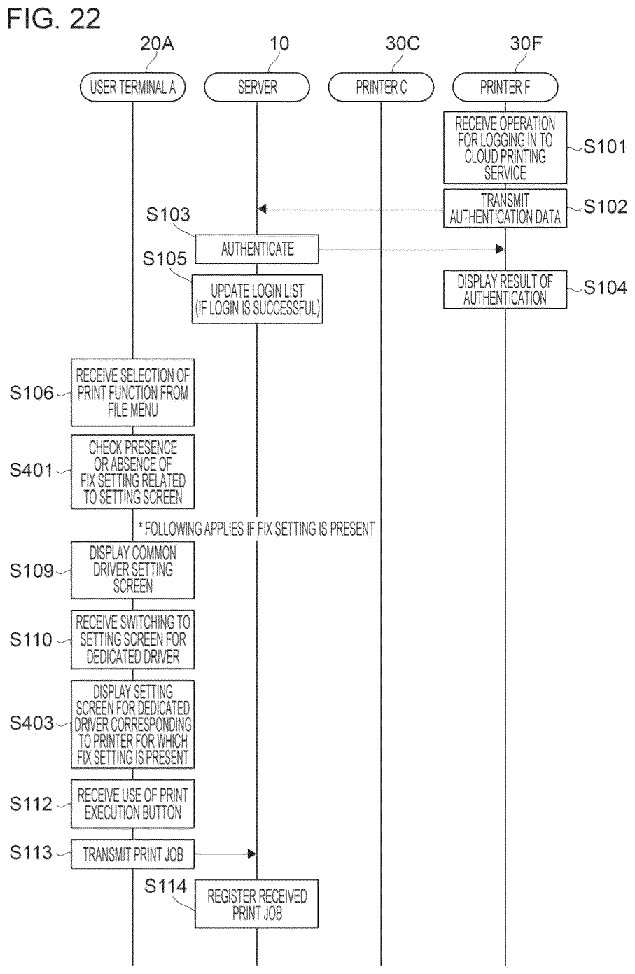

FIG. 22 is a diagram illustrating another example of the processing sequence in the case where, after enabling the fix setting of the setting screen 260D (see FIG. 16) for the dedicated driver corresponding to the printer 30C, the user logs in to the cloud printing service with another printer 30F and then registers a print job. In FIG. 22, elements corresponding to those in FIG. 18 are given the same reference numerals.

In FIG. 22, too, processing operations up to step 106 are the same as those in FIG. 18.

In FIG. 22, however, if it is checked in step 401 that the fix setting is “present”, the common driver setting screen 260B (see FIG. 11) is displayed without requesting the login list 14A (see FIG. 3) from the server 10 (step 109), and then switching to a setting screen for a dedicated driver is received (step 110).

In FIG. 22, since the fix setting is “present”, the user terminal 20A displays the setting screen 260D for the dedicated driver corresponding to the printer 30C having the fix setting (step 403).

The user terminal 20A then receives use of the print execution button 262 on the menu screen 260A (see FIG. 10) (step 112).

Thereafter, the user terminal 20A transmits the print job to the server 10 (step 113).

The server 10, on the other hand, registers the received print job (step 114).

In FIG. 22, if the fix setting is absent in step 401, the user terminal 20A sequentially performs the processing operations in step 107 and the later steps in FIG. 15.

### SUMMARY

When the cloud printing system 1 (see FIG. 1) described in the present exemplary embodiment is employed, the user can display the setting screen for the dedicated driver corresponding to the printer 30C for which the fix setting has been enabled only by using the “dedicated mode” button 266, instead of the setting screen for the dedicated driver corresponding to the printer 30F with which the user has performed the last login operation.

With this function, even when the user has logged in, due to temporary circumstances, to the cloud printing service using the printer 30F different from the printer 30C, which is usually used by the user, the user can more easily call the setting screen for the dedicated driver corresponding to the printer 30C by using the “dedicated mode” button 266 immediately thereafter.

In the case of the above-described mechanism, the user might desire to perform printing using functions and prohibitions that are not supported by the printer 30C but are supported by the printer 30F. In this case, if the user logs in to the server 10 from the printer 30F after temporarily disabling the fix setting for the printer 30C, the user can easily call the setting screen for the printer 30F whose IP address and device name are unknown.

The user who has completed the printing using the printer 30F can move to the printer 30C again, log in to the cloud printing service, call the setting screen corresponding to printer 30C whose IP address and device name are unknown, and newly enable the fix setting.

In this mechanism, however, the user needs to move to the printer 30C, which is usually used by the user, after performing temporary printing.

The user, therefore, is enabled to select, from the common driver setting screen 260B (see FIG. 11), calling of the setting screen for the dedicated driver corresponding to the printer 30F with which the user has logged in last and calling of the setting screen for the dedicated driver corresponding to the printer 30C for which the fix setting has been enabled.

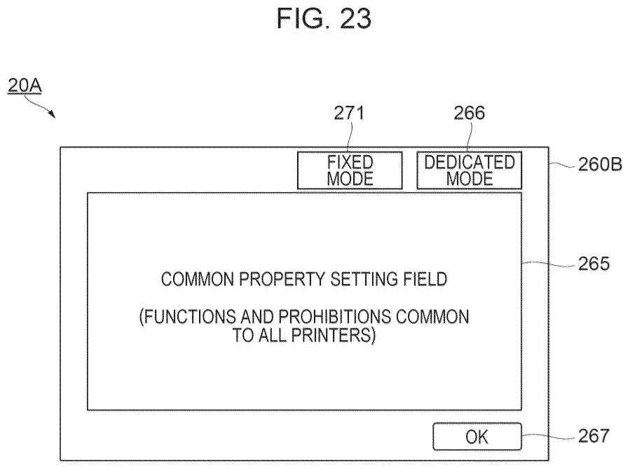

FIG. 23 is a diagram illustrating another display example of the common driver setting screen 260B.

In FIG. 23, elements corresponding to those in FIG. 11 are given the same reference numerals.

A “fix mode” button 271 is added to the setting screen 260B illustrated in FIG. 23.

The “fix mode” button 271 is a button for calling the setting screen for the dedicated driver corresponding to the printer 30C for which the fix setting has been enabled.

The “dedicated mode” button 266 is a button for calling the setting screen for the dedicated driver corresponding to the printer 30F with which the user has logged in last.

By preparing these two buttons, the user A can freely select which setting screen is to be displayed.

Even when the user desires to perform printing using the printer 30C, which is usually used by the user, after performing printing using the printer 30F that supports special functions and prohibitions, the user can call the setting screen 260D for the dedicated driver corresponding to the printer 30C without logging in again to the cloud printing service from the printer 30C.

### Third Exemplary Embodiment

In the present exemplary embodiment, too, a modification of the first exemplary embodiment will be described.

A cloud printing system 1 (see FIG. 1) assumed in the third exemplary embodiment, therefore, is the same as the cloud printing system 1 described in the first exemplary embodiment.

Hardware configuration and the like of a server 10 (see FIG. 1), user terminals 20 (see FIG. 1), and printers 30 (see FIG. 1) assumed in the third exemplary embodiment, too, are the same as those in the first exemplary embodiment.

Two differences lie in the processing performed by the cloud print drivers 24A (see FIG. 4) and the server cooperative app 24B (see FIG. 4) and the processing performed by the server 10.

### Description of Processing Operations

Processing operations performed by the cloud printing system 1 (see FIG. 1) assumed in the third exemplary embodiment will be described hereinafter.

### Until Initial Registration of Print Job

### Processing Sequence

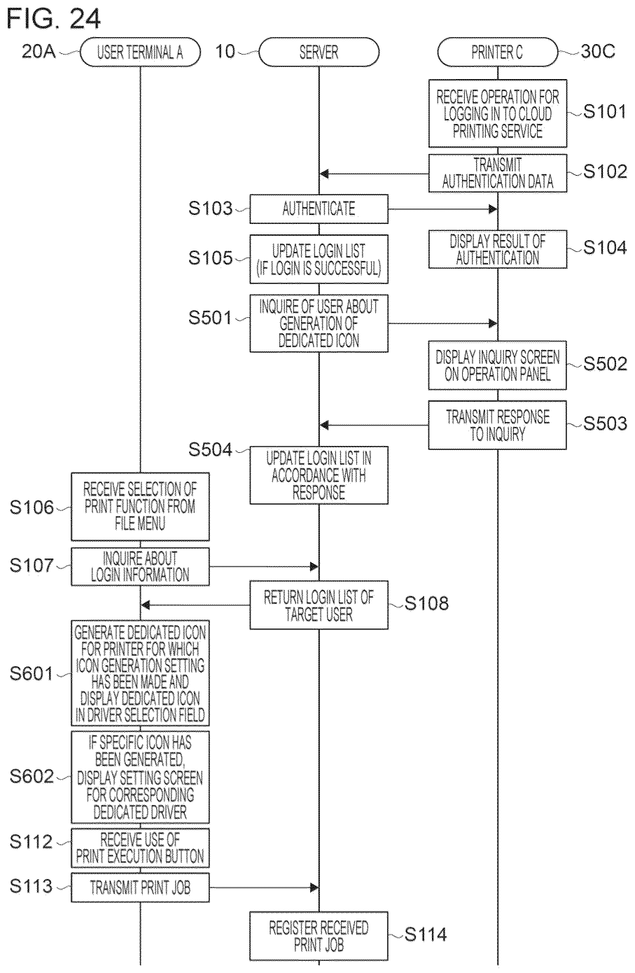

FIG. 24 is a diagram illustrating an example of a processing sequence according to the third exemplary embodiment related to initial registration of a print job. In FIG. 24, elements corresponding to those in FIG. 7 are given the same reference numerals.

In the processing sequence illustrated in FIG. 24, the server 10 updates the login list 14A (see FIG. 3) and then inquires of, through the printer 30C, the user about generation of a dedicated icon (step 501).

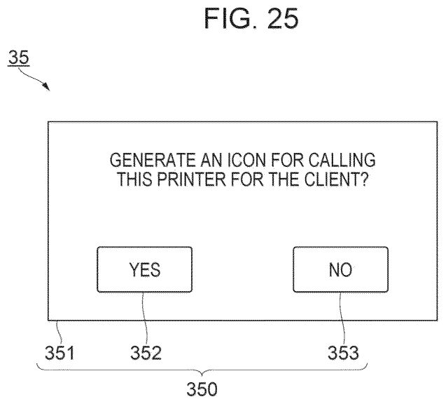

Upon receiving the inquiry, the printer 30C displays an inquiry screen 350 (see FIG. 25) on the operation panel 35 (step 502).

FIG. 25 is a diagram illustrating an example of the inquiry screen 350 displayed on the operation panel 35.

The inquiry screen 350 illustrated in FIG. 25 includes an inquiry sentence 351, a “YES” button 352, and a “NO” button 353.

In FIG. 25, “Generate an icon for calling this printer for the client?” is displayed as the inquiry sentence 351. After viewing this display, the user A uses the “YES” button 352 or the “NO” button 353. Detection of use of the “YES” button 352 is an example of a case where a predetermined condition is satisfied.

FIG. 24 will be referred to again.

The printer 30C transmits a response to the inquiry to the server 10 (step 503).

The server 10 updates the login list 14A in accordance with the response (step 504).

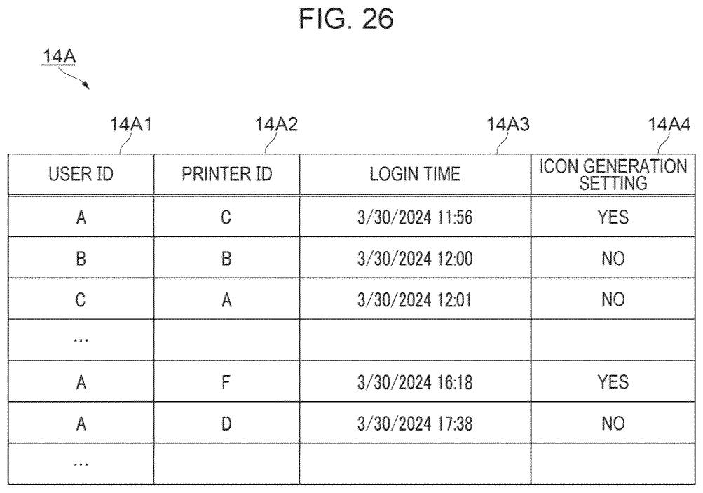

FIG. 26 is a diagram illustrating an example of data structure of the login list 14A used in the third exemplary embodiment. In FIG. 26, elements corresponding to those in FIG. 3 are given the same reference numerals.

An icon generation setting 14A4 is added to the login list 14A illustrated in FIG. 26.

In FIG. 26, the user A has set generation of an icon for the printers 30C and 30F, but has not set generation of an icon for the printer 30D.

FIG. 24 will be referred to again.

In the present exemplary embodiment, too, the user terminal 20A receives selection of the print function from a file menu of a document after the user logs in to the cloud printing service from the printer 30C (step 106).

When the print function is selected, the user terminal 20A accesses the server through the server cooperative app 24B (see FIG. 4) and inquires about login information (step 107).

The server 10 returns the login list 14A (see FIG. 2) of the target user as a response to the inquiry (step 108).

The user terminal 20A generates a dedicated icon for the printer 30 for which an icon generation setting has been made, and displays the dedicated icon in the driver selection field 263 (step 601).

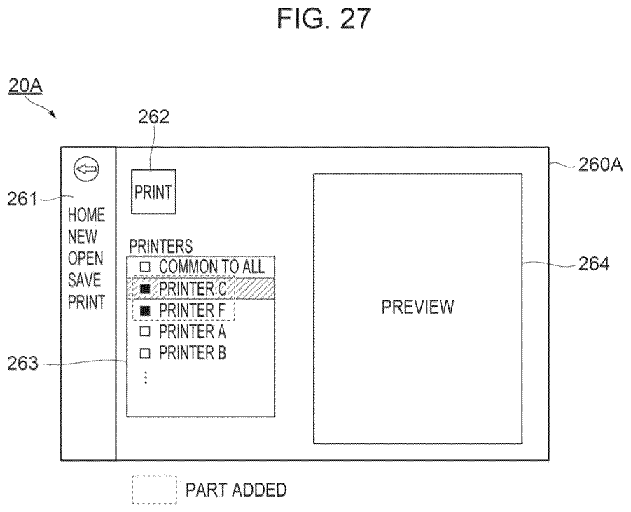

FIG. 27 is a diagram illustrating a display example of the menu screen 260A according to the third exemplary embodiment. In FIG. 27, elements corresponding to those in FIG. 10 are given the same reference numerals.

In FIG. 27, an icon of the printer 30C and an icon of the printer 30F, for which the icon generation setting has been made, are added to the driver selection field 263. In FIG. 27, an icon and a device name are displayed as a set.

The icons corresponding to the specific printers 30C and 30F generated as a result of an instruction from the user A are arranged immediately below an icon corresponding to the common driver as illustrated in FIG. 27.

In the present exemplary embodiment, the icons corresponding to the specific printers 30C and 30F can be distinguished from icons prepared by default in terms of design, display color, and other display forms. As a result, the user can easily identify the icons corresponding to the printers 30C and 30F, which have been generated as a result of an instruction from the user.

The two icons corresponding to the printers 30C and 30F are not generated at once. It is also possible, therefore, to identify correspondence between newly added icons and the specific printers 30C and 30F.

FIG. 24 will be referred to again.

When a specific icon is selected, the user terminal 20A displays a setting screen for a corresponding dedicated driver (step 602).

When the icon corresponding to the printer 30C is selected, for example, the user terminal 20A displays the setting screen for the driver corresponding to the printer 30C.

When the icon corresponding to the common driver is selected, the user terminal 20A displays the common driver setting screen 260B (see FIG. 10).

Thereafter, when the user terminal 20A receives use of the print execution button 262 on the menu screen 260A (see FIG. 10) (step 112), the user terminal 20A transmits a print job to the server 10 (step 113).

The server 10, on the other hand, registers the received print job (step 114).

### SUMMARY

When the cloud printing system 1 (see FIG. 1) described in the present exemplary embodiment is employed, the user can easily find an icon of a printer 30 generated as a result of an instruction from the user near a top of the driver selection field 263. For example, an icon generated as a result of an instruction from the user A is disposed immediately below the icon corresponding to the common driver.

Even when a large number of icons are displayed in the driver selection field 263, therefore, the user A can easily call the setting screen for the driver corresponding to the printer 30C or 30F that the user A desires to use.

Although an icon generated as a result of an instruction from the user A is displayed in the driver selection field 263 in the above-described mechanism, the icon may be displayed as an operation button in the common driver setting screen 260B, instead.

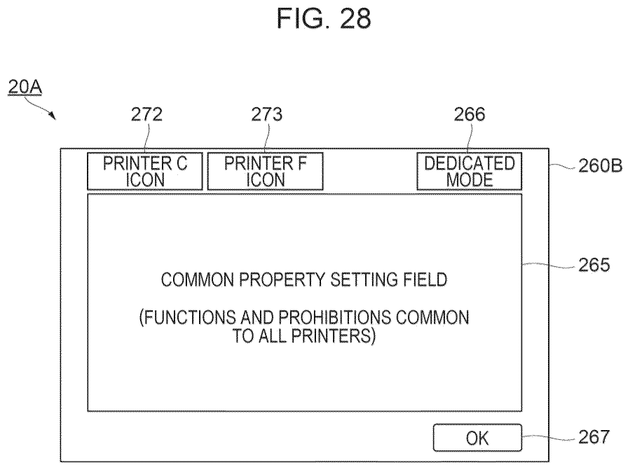

FIG. 28 is a diagram illustrating a display example of the common driver setting screen 260B according to the third exemplary embodiment. In FIG. 28, elements corresponding to those in FIG. 10 are given the same reference numerals.

In the setting screen 260B illustrated in FIG. 28, a “printer C icon” button 272, which is an icon for calling the dedicated driver corresponding to the printer 30C, and a “printer F icon” button 273, which is an icon for calling the dedicated driver corresponding to the printer 30F, are added.

By employing this display mode, the user A can easily distinguish between an icon generated as a result of an instruction therefrom and an icon initially displayed in the driver selection field 263.

### Other Exemplary Embodiments

(1) Although exemplary embodiments of the present disclosure have been described above, the technical scope of the present disclosure is not limited to that described in the above-described exemplary embodiments. It is apparent from the description in the claims that the technical scope of the present disclosure also includes modes obtained by modifying or improving the above-described exemplary embodiments in various manners.
(2) Although the server 10, the user terminals 20, and the printers 30 are connected to the cloud network N in the description of the above exemplary embodiments, these terminals may be connected to a local area network (LAN), instead.
(3) Although the login list 14A is requested from the server 10 after the print function is selected in the file menu in the description of the above exemplary embodiments, the login list 14A (see FIG. 3) may be requested from the server 10 after the “dedicated mode” button 266 (see FIG. 11) is used on the common driver setting screen 260B (see FIG. 11), instead.

That is, an inquiry for requesting the login list 14A may be transmitted to the server 10 only when the user desires to display a setting screen for a dedicated driver corresponding to a printer 30 with which the user has logged in last.

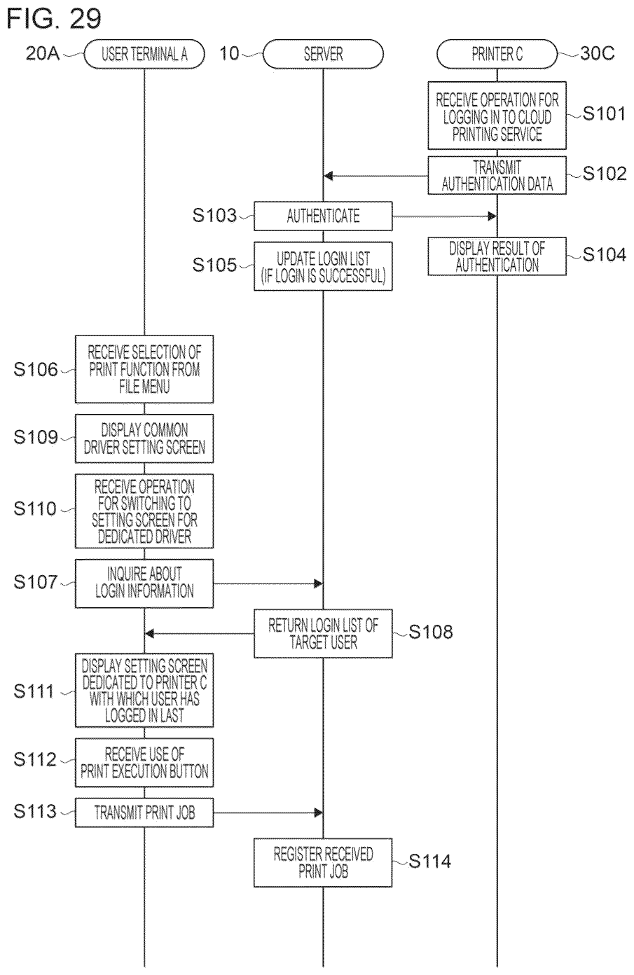

FIG. 29 is a diagram illustrating another example of the processing sequence related to initial registration of a print job. In FIG. 29, elements corresponding to those in FIG. 7 are given the same reference numerals.

In FIG. 29, steps 109 and 110 are performed after execution of step 106, and then steps 107 and 108 are performed.

That is, in FIG. 29, when an operation for switching to a setting screen for a dedicated driver is received on the common driver setting screen 260B, the user terminal 20A inquires of the server 10 about login information, and the server 10 returns the login list 14A of the target user.
(4) Although the server 10 returns the login list 14A to the user terminal 20A in step 108 (see FIG. 7) in the description of the above exemplary embodiments, only information for identifying a printer 30 with which the user A, who operates the user terminal 20A, has logged in last may be notified of, instead. That is, even when there is a plurality of records of login times associated with the user A as in the login list 14A of an addition type, only a device name or an IP address corresponding to the last login may be notified of.
(5) Although a dedicated icon for identifying a printer 30 in operation is generated when the user A gives an instruction to generate the icon after logging in to the cloud printing service in the description of the above exemplary embodiments, the icon may also be automatically generated when the number or frequency of login operations exceeds a predetermined criterion. The criterion being exceeded here is an example of a case where a predetermined condition is satisfied.
(6) In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

### APPENDIX

(((1)))
   An information processing system comprising:
   a user terminal; and
   a server that transmits a print job registered from the user terminal to a printer selected as a destination,
   wherein the server notifies the user terminal of, as a response to an inquiry from the user terminal, information for identifying a printer used by a user who operates the user terminal to log in to a printing service, and
   wherein the user terminal displays a first setting screen corresponding to the printer identified by the information obtained from the server.
(((2)))
   The information processing system according to (((1))),
   wherein, when the user terminal receives an operation for printing a document, the user terminal displays a second setting screen common to a plurality of printers as an initial screen, and
   wherein, when the user terminal receives an operation for switching to the first setting screen on the second setting screen, the user terminal transmits the inquiry to the server.
(((3)))
   The information processing system according to (((2))),
   wherein, when a setting for fixing a setting screen to be displayed as the first setting screen is present, the user terminal displays, after receiving the operation for switching to the first setting screen, an operation screen set as a target to be fixed.
(((4)))
   The information processing system according to any of (((1))) to (((3))),
   wherein, when the user terminal receives an operation for printing a document, the user terminal transmits the inquiry to the server.
(((5)))
   The information processing system according to any of (((1))) to (((4))),
   wherein, when a predetermined condition is satisfied, the user terminal generates an icon for calling the first setting screen.
(((6)))
   The information processing system according to any of (((1))) to (((5))),
   wherein, when the server detects new login to the printing service, the server updates a list of combinations of a printer used for login and a user who has logged in with the printer.
(((7)))
   The information processing system according to (((6))),
   wherein, when there is a plurality of records of printers used, for login, by the user corresponding to the inquiry, the server notifies the user terminal of information for identifying a printer corresponding to the last login.
(((8)))
   The information processing system according to any of (((1))) to (((7))),
   wherein, when the server detects new login from the printer, the server causes the printer to display a screen for inquiring about generation of an icon for calling, on the user terminal, the first setting screen corresponding to the printer used for the login.
(((9)))
   A user terminal that specifies a printer as a destination and that registers a print job to a server, the user terminal comprising:
   one or a plurality of processors,
   wherein the one or plurality of processors inquires of the server about information for identifying a printer used by a user who operates the user terminal to log in to a printing service and displays a first setting screen corresponding to the printer identified by the information obtained from the server.
(((10)))
   A server that transmits a print job registered from a user terminal to a printer specified as a destination, the server comprising:
   one or a plurality of processors,
   wherein the one or plurality of processors notifies the user terminal of, as a response to an inquiry from the user terminal, information for identifying the printer used by a user who operates the user terminal to log in to a printing service.
(((11)))
   A program causing a computer that functions as a user terminal which specifies a printer as a destination and which registers a print job to a server to execute a process comprising:
   inquiring of the server about information for identifying a printer used by a user who operates the user terminal to log in to a printing service; and
   displaying a first setting screen corresponding to the printer identified by the information obtained from the server.
(((12)))
   A program causing a computer that functions as a server which transmits a print job registered from a user terminal to a printer specified as a destination to execute a process comprising:
   notifying the user terminal of, as a response to an inquiry from the user terminal, information for identifying the printer used by a user who operates the user terminal to log in to a printing service.

What is claimed is:

1. An information processing system comprising:
a user terminal; and
a server that transmits a print job registered from the user terminal to a printer selected as a destination,
wherein the server notifies the user terminal of, as a response to an inquiry from the user terminal, information for identifying a printer used by a user who operates the user terminal to log in to a printing service, and
wherein the user terminal displays a first setting screen corresponding to the printer identified by the information obtained from the server.

2. The information processing system according to claim 1,
wherein, when the user terminal receives an operation for printing a document, the user terminal displays a second setting screen common to a plurality of printers as an initial screen, and
wherein, when the user terminal receives an operation for switching to the first setting screen on the second setting screen, the user terminal transmits the inquiry to the server.

3. The information processing system according to claim 2,
wherein, when a setting for fixing a setting screen to be displayed as the first setting screen is present, the user terminal displays, after receiving the operation for switching to the first setting screen, an operation screen set as a target to be fixed.

4. The information processing system according to claim 1,
wherein, when the user terminal receives an operation for printing a document, the user terminal transmits the inquiry to the server.

5. The information processing system according to claim 1,
wherein, when a predetermined condition is satisfied, the user terminal generates an icon for calling the first setting screen.

6. The information processing system according to claim 1,
wherein, when the server detects new login to the printing service, the server updates a list of combinations of a printer used for login and a user who has logged in with the printer.

7. The information processing system according to claim 6,
wherein, when there is a plurality of records of printers used, for login, by the user corresponding to the inquiry, the server notifies the user terminal of information for identifying a printer corresponding to the last login.

8. The information processing system according to claim 1,
wherein, when the server detects new login from the printer, the server causes the printer to display a screen for inquiring about generation of an icon for calling, on the user terminal, the first setting screen corresponding to the printer used for the login.

9. A non-transitory computer readable storage medium storing a program causing a computer that functions as a user terminal which specifies a printer as a destination and which registers a print job to a server to execute a process comprising:
inquiring of the server about information for identifying a printer used by a user who operates the user terminal to log in to a printing service; and
displaying a first setting screen corresponding to the printer identified by the information obtained from the server.

10. A non-transitory computer readable storage medium storing a program causing a computer that functions as a server which transmits a print job registered from a user terminal to a printer specified as a destination to execute a process comprising:
notifying the user terminal of, as a response to an inquiry from the user terminal, information for identifying the printer used by a user who operates the user terminal to log in to a printing service.
